(19) United States
(12) Patent Application Publication
(10) Pub. No.: US 2024/0339957 A1
(43) Pub. Date: Oct. 10, 2024

(54) HORIZONTAL DUAL-AXIS SOLAR TRACKING SYSTEM

(71) Applicants: S.K. Radhakrishnan, Coimbatore (IN); R. Savithiri, Coimbatore (IN)

(72) Inventors: S.K. Radhakrishnan, Coimbatore (IN); R. Savithiri, Coimbatore (IN)

(21) Appl. No.: 18/579,423

(22) PCT Filed: Jul. 11, 2022
(86) PCT No.: PCT/IB2022/056370

§ 371 Date: Jan. 15, 2024

(30) Foreign Application Priority Data
Jul. 15, 2021 (IN) 202141031981

(51) Int. Cl. H02S 20/32; H02S 30/10

(52) U.S. Cl. CPC H02S 20/32; H02S 30/10

(57) ABSTRACT

The present invention provides a horizontal dual-axis solar tracking system comprising a frame assembly (5), the frame assembly (5) comprises a plurality of cross frames (35); a plurality of panel holder assemblies (12) linked to the frame assembly (5), each panel holder assembly (12) comprising a photovoltaic panel (6); a first N-S motion imparting assembly and a second N-S motion imparting assembly (16) co-operating with the plurality of panel holder assemblies (12) and adapted to cause the plurality of panel holder assemblies to exhibit N-S tilting motion with respect to the frame assembly (5); a plurality of pillar assemblies (3, 4) pivotally connected to the plurality of cross frames (35); and a ring gear (34) attached to a bottom surface of a cross frames (35), the ring gear (34) being operably connected to a E-W motion imparting assembly (36) located on the pillar assembly (3, 4) with which the cross frame (35) is pivotally connected.

### FIELD OF ART

This invention relates to the field of solar energy, and more particularly to a horizontal two-axis sun-tracking-type system that tilts plurality of solar photovoltaic panels.

### BACKGROUND OF THE ART

In general, a solar photovoltaic panel consisting of plurality of solar cells is a generator that collects sun rays and converts the solar energy into electrical energy. Installation of the solar photovoltaic panel may be categorized into “fixed-type” and “sun-tracking-type”. A solar photovoltaic panel having a fixed type of installation may be referred to as “fixed tilt type system” while a solar photovoltaic panel having sun-tracking-type installation may be referred to as “sun-tracking-type system”

In the fixed tilt type system, one or more solar photovoltaic panel is fixedly disposed on a frame at a predefined angle at which the one or more solar photovoltaic panel can receive the most amounts of sun rays. This installation is simple and easy to install, and has a high durability and simple maintenance, whereas the amount of power generated varies drastically with the angle of incidence of sun rays, resulting in a low average efficiency of generation.

In the sun-tracking-type system, the one or more solar photovoltaic panel is disposed on a tiltableframe. One or more driving motors tilt the frame on which the one or more solar photovoltaic panel is mounted so as to track the sun. In the sun-tracking-type system there are two categories namely single-axis sun-tracking-type system and two-axis sun-tracking-type system.

In the single-axis sun-tracking-type system, the one or more solar photovoltaic panel tracks the sun from sunrise to sunset as the sun moves from the east to the west. Thus, in this system, the one or more solar photovoltaic panel is tilted along a single axis which is generally aligned with the East-West direction on a daily basis.

On the other hand, in the two-axis sun-tracking-type system the one or more solar photovoltaic panel is tilted to track the changes in a meridian altitude of the sun. Thus, in this system, the one or more solar photovoltaic panel is tilted along a first axis which is generally aligned with the East-West direction, and a second axis which is generally aligned with the North-South direction.

The single-axis sun-tracking-type system has a comparatively simple structure with less efficiency compared to the two-axis sun-tracking-type system. For example, the approximate productivity increase of the single-axis sun-tracking-type system is said to be in the order of 16% (yearly average) over an equivalent fixed tilt type system while the approximate potential increase in the productivity of the two-axis sun-tracking-type system is said to be around 35% (yearly average) over an equivalent fixed tilt type system.

While a number of documents disclose a dual-axis solar tracking system, the systems are highly complicated in terms of their construction. Furthermore, such systems are not having the simplicity in terms of their operation, and are also not having desired accuracy level in terms of positioning. Moreover, the existing systems have several disadvantages including warpage of panels; back lash in the tilting, requirement of more torques for tilting.

Thus, the objective of the present invention is to provide a horizontal dual-axis solar tracking system constructed so as to address one or more of the above identified problems.

### SUMMARY OF THE INVENTION

This summary is provided to introduce a selection of concepts in a simplified format that are further described in the detailed description of the invention. This summary is neither intended to identify key or essential inventive concepts of the invention, and nor is it intended for determining the scope of the invention.

Accordingly, the present invention provides a horizontal dual-axis solar tracking system comprising a frame assembly (5), the frame assembly (5) comprises a plurality of cross frames (35); a plurality of panel holder assemblies (12) linked to the frame assembly (5), each panel holder assembly (12) comprising a photovoltaic panel (6); a first N-S motion imparting assembly and a second N-S motion imparting assembly (16) co-operating with the plurality of panel holder assemblies (12) and adapted to cause the plurality of panel holder assemblies to exhibit N-S tilting motion with respect to the frame assembly (5); a plurality of pillar assemblies (3, 4) pivotally connected to the plurality of cross frames (35); and a ring gear (34) attached to a bottom surface of a cross frames (35), the ring gear (34) being operably connected to a E-W motion imparting assembly (36) located on the pillar assembly (3, 4) with which the cross frame (35) is pivotally connected.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE FIGURES

In order that the invention may be readily understood and put into practical effect, reference will now be made to exemplary embodiments as illustrated with reference to the accompanying drawings, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 illustrates an overall view of the horizontal dual-axis solar tracking system constructed in accordance with an embodiment of the present invention;

FIG. 2a illustrates the horizontal dual-axis solar tracking system wherein the photovoltaic panels are tilted towards north in accordance with an embodiment of the present invention;

FIG. 2b illustrates the horizontal dual-axis solar tracking system wherein the photovoltaic panels are tilted towards south in accordance with an embodiment of the present invention;

FIG. 2c illustrates the horizontal dual-axis solar tracking system wherein the photovoltaic panels are tilted towards east in accordance with an embodiment of the present invention;

FIG. 2d illustrates the horizontal dual-axis solar tracking system wherein the photovoltaic panels are tilted towards west in accordance with an embodiment of the present invention;

FIG. 3 illustrates a detailed view of the frame assembly in accordance with an embodiment of the present invention;

FIG. 4a illustrates a detailed view of the panel holder assembly with the photovoltaic panel in accordance with an embodiment of the present invention;

FIG. 4b illustrates a detailed view of the panel holder assembly showing in particular the set of “C” shaped panels (13) in accordance with an embodiment of the present invention:

FIG. 5 illustrates a partial detailed view of the N-S motion imparting assembly which is used for imparting N-S motion to the panel holder assemblies in accordance with an embodiment of the present invention;

FIG. 6a illustrates a close-up view of a first portion marked I in FIG. 5a in accordance with an embodiment of the present invention;

FIG. 6b illustrates an exploded view of the first portion marked I in FIG. 5a in accordance with an embodiment of the present invention;

FIG. 7a illustrates a close-up view of a first portion marked II in FIG. 5a in accordance with an embodiment of the present invention;

FIG. 7b illustrates an exploded view of the second portion marked II in FIG. 5a in accordance with an embodiment of the present invention;

FIG. 8a illustrates a close-up view showing the connection between one panel holder assembly and the N-S motion imparting assembly in accordance with an embodiment of the present invention;

FIG. 8b illustrates the N-S motion imparting assembly being in a central position in accordance with an embodiment of the present invention;

FIG. 8c illustrates the N-S motion imparting assembly tilting towards north in accordance with an embodiment of the present invention;

FIG. 8d illustrates the N-S motion imparting assembly tilting towards south in accordance with an embodiment of the present invention;

FIG. 9 illustrates an overall view of the connection between the cross frame and pillar assembly via the ring gear and the E-W motion imparting assembly in accordance with an embodiment of the present invention; and

FIG. 10 illustrates an exploded view of the connection between the ring gear and an E-W gear box assembly in accordance with an embodiment of the present invention.

It may be noted that to the extent possible, like reference numerals have been used to represent like elements in the drawings. Further, skilled artisans will appreciate that elements in the drawings are illustrated for simplicity and may not have been necessarily been drawn to scale. For example, the dimensions of some of the elements in the drawings may be exaggerated relative to other elements to help to improve understanding of aspects of the present invention. Furthermore, the one or more elements may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

As used herein, and unless the context dictates otherwise, the terms “coupled to”, “connected to”, “operably connected to”, “operatively connected to” are intended to include both direct connection/coupling (in which two elements that are coupled/connected to each other contact each other) and indirect coupling/connection (in which at least one additional element is located between the two elements). Therefore, the terms “coupled to” and “coupled with” are used synonymously. Similarly, the terms “connected to” and “connected with” are used synonymously.

Unless otherwise defined, all technical and scientific terms used herein have the same meaning as commonly understood by one of ordinary skilled in the art to which this invention belongs. The device, methods, and examples provided herein are illustrative only and not intended to be limiting.

The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Embodiments of the present invention will be described below in detail with reference to the accompanying drawings.

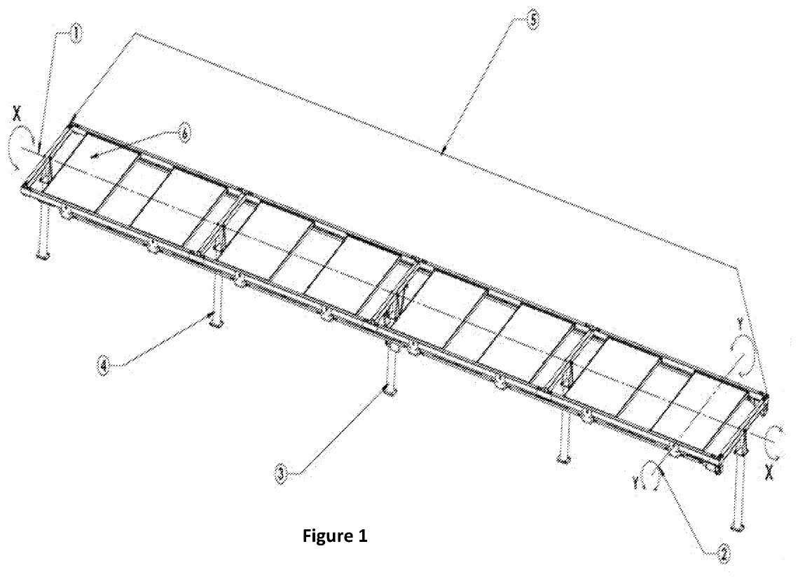

Now referring to FIG. 1, the present invention provides a horizontal dual-axis solar tracking system comprising a frame assembly (5) carrying a plurality of photovoltaic panels (6). The horizontal dual-axis solar tracking system further comprises a plurality of pillar assemblies (3, 4). The plurality of photovoltaic panels (6) are pivotally connected to the plurality of pillar assemblies (3, 4). The horizontal dual-axis solar tracking system exhibits movement along a X-X axis (1) (which will be taken as movement in the E-W direction) and movement along a Y-Y axis (2) (which will be taken as movement in the N-S direction).

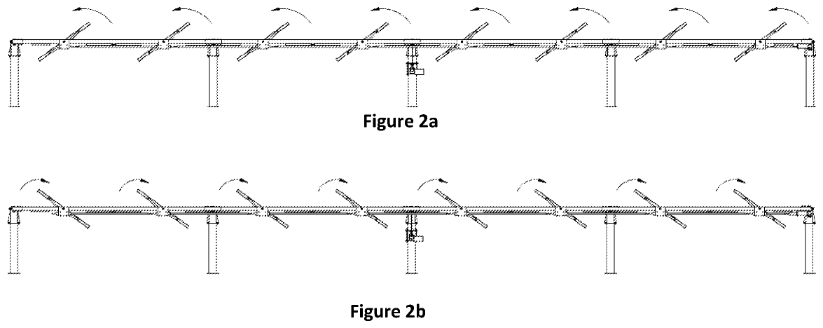

Now referring to FIGS. 2a to 2d, it can be seen that horizontal dual-axis solar tracking system exhibits movement in the E-W direction as well as in the N-S direction. In particular, it can be seen that from FIG. 2a, that the plurality of photovoltaic panels (6) are rotatable in the North direction while from FIG. 2b, it can be seen that the plurality of photovoltaic panels (6) are rotatable in the South direction. It can be seen from FIG. 2a and FIG. 2b that when the horizontal dual-axis solar tracking system exhibits movement in the N-S direction the frame assembly does not tilt and only the plurality of photovoltaic panels (6) are tilted.

On the other hand, it can be seen that from FIG. 2c, that the frame assembly is rotatable in the East direction while from FIG. 2d, it can be seen that the frame assembly is rotatable in the West direction. When the frame assembly is rotating either towards east direction or towards the west direction, the plurality of photovoltaic panels (6) automatically gets tilted in the corresponding east/west direction.

Although not shown, it is possible to tilt both the frame assembly and the plurality of photovoltaic panels (6) simultaneously or one after the other in any sequence. Thus, the horizontal dual-axis solar tracking system can easily track sun's position in the sky and aligns the plurality o photovoltaic cells in such a way that they receive the most amount of sun rays.

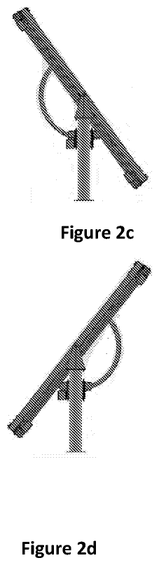

Now referring to FIG. 3, there is illustrated a more detailed view of the frame assembly (5). The frame assembly (5) is essentially of single frame assembly structure and comprises a pair of straight frame members (43) which are parallel to one another and between which are connected a plurality of cross frame members (35). The present invention comprises a single frame assembly structure is having less length, is comparatively compact and has more strength. A straight frame member (43) may be joined to a cross frame member (35) at intermediate positions using “T” shaped joints (8). A straight frame member (43) may be joined to a cross frame member (35) at its ends using “L” shaped joints (9). The frame assembly (5) is further provided with a set of piston assembly holders (7). Also, the frame assembly (5) is provided with a set of panel holder shaft provisions (10 and 11).

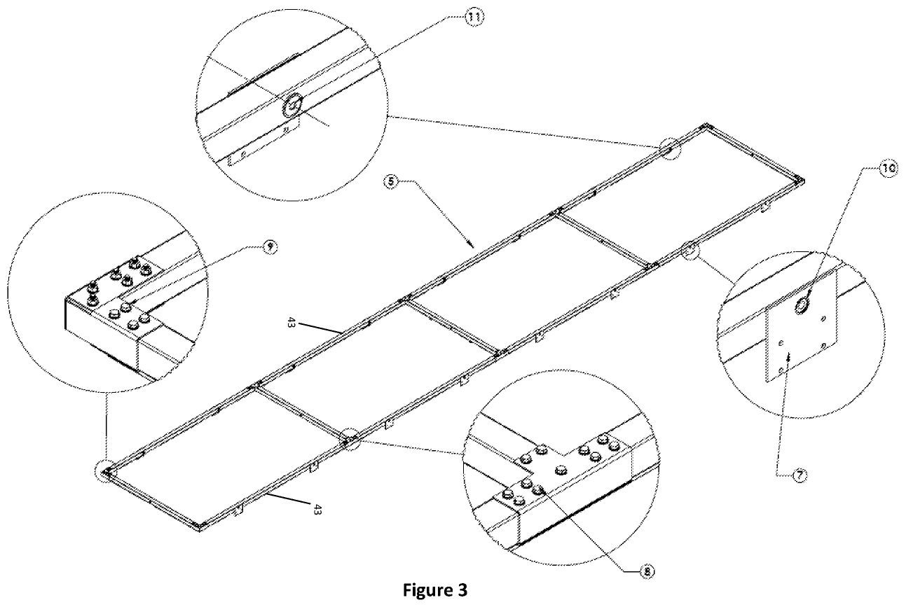

Now referring to FIGS. 4a and 4b, there is illustrated a more detailed view of a panel holder assembly (12). A panel holder assembly (12) is used for coupling a photovoltaic panel (6) to the frame assembly (5). Thus, the horizontal dual-axis solar tracking system comprises a plurality of panel holder assemblies (12) linked to the frame assembly (5) and adapted to exhibit N-S tilting motion with respect to the frame assembly (5). Also, it may be noted that when reference to N-S movement of the photovoltaic panel (6), also refers to N-S movement of the panel holder assembly (12) which houses the photovoltaic panel (6). Each panel holder assembly (12) comprises a set of “C” shaped panels (13) adapted to be located on two opposing sides of the photovoltaic panel (6). Each “C” shaped panel (13) comprises a panel holder shaft (14) and a N-S lever assembly (15). The panel holder shaft (14) is pivotally received by the panel holder shaft provisions (10 and 11) as provided in the frame assembly (5).

The horizontal dual-axis solar tracking system further comprises a first N-S motion imparting assembly and a second N-S motion imparting assembly (16). The first N-S motion imparting assembly (16) is connected to N-S lever assemblies (15) arranged on a first side of the plurality of panel holder assemblies (12) and the second N-S motion imparting assembly (16) is connected to N-S lever assemblies (15) arranged on a second side of the plurality of panel holder assemblies (12).

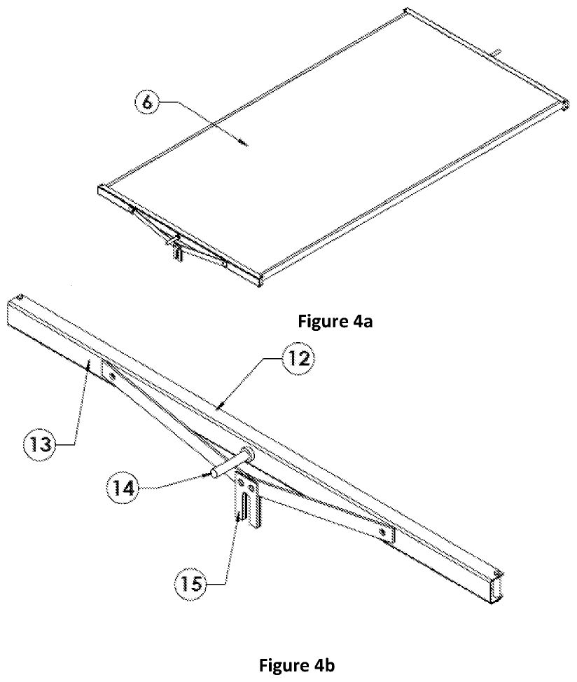

Now referring to FIG. 5, there is illustrated a partial detailed view of the N-S motion imparting assembly (16) which is used for imparting N-S pivotal motion to the panel holder assemblies in accordance with an embodiment of the present invention. The N-S motion imparting assembly (16) comprises a first portion marked as “I” and a plurality of second portions marked as “II”. The first portion “I” is connected to the second portion II using connecting rod (40). The second portions “II” are connected to one another using connecting rods (41). The first portion “I” generates a lateral movement and the second portions “II” transfer the lateral movement to the plurality of panel holder assemblies (12). However, since each of the panel holder assembly (12) is pivotally attached to the frame assembly (via the panel holder shaft (14) and the panel holder shaft provisions (10 and 11)), the panel holder assembly (12) exhibits a pivotal movement in response to receiving the lateral movement from the second portions II.

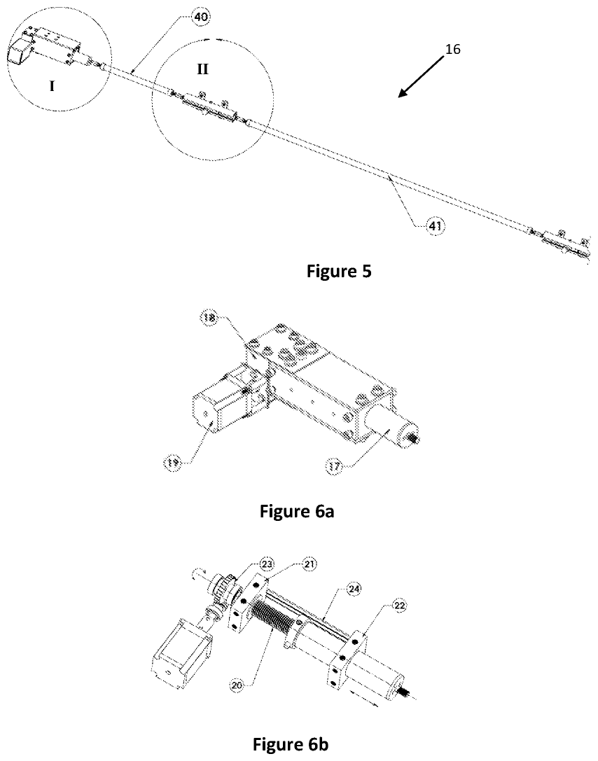

Now referring to FIG. 6a, there is illustrated a close-up view of the first portion marked I in FIG. 5a, in accordance with an embodiment of the present invention. Since the first portion “I” generates a lateral movement, it may be referred to as lateral movement generating mechanism. The lateral movement generating mechanism comprises N-S motor (19) which is connected to a linear motion shaft (17) via a suitable gear-box (18).

Now referring to FIG. 6b, there is illustrated an exploded view of the first portion marked I in FIG. 5a, in accordance with an embodiment of the invention. It can be seen that the N-S motor (19) is provided with a worm portion (not numbered), which is operably connected to a worm wheel (23). The worm wheel (23) is connected to a threaded shaft (20), which is located between two junctions (21 and 22). The linear motion shaft (17) is connected to the threaded shaft (20). There may additionally provided a linear motion shaft guide rail (24) that ensures that linear motion of the shaft (17). Thus, it can be seen that the gear box (18) houses the worm portion (not numbered), the worm wheel (23), the threaded shaft (20), the two junctions (21 and 22) and the linear motion shaft guide rail (24).

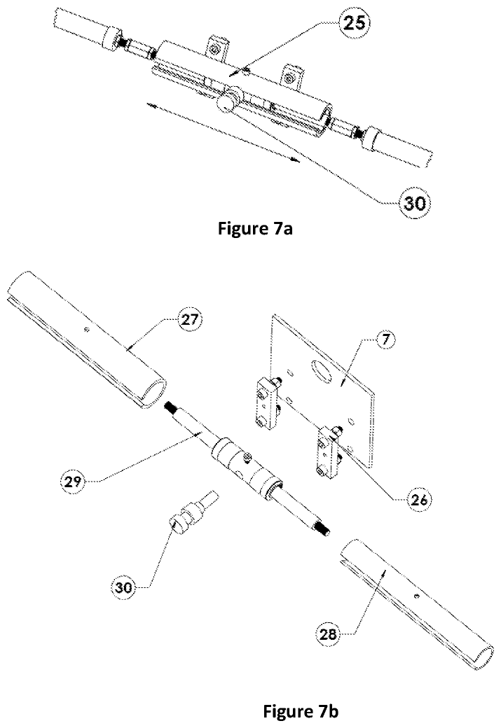

Now referring to FIG. 7a, there is illustrated a close-up view of a second portion marked II in FIG. 5a in accordance with an embodiment of the present invention. Since the second portion “II” comprises piston like elements, it is being referred to as the piston connection mechanism (25).

Now referring to FIG. 7b, which is an exploded view of the piston connection mechanism, it can be seen that the piston connection mechanism (25) comprises an outer cylinder support (26), an outer cylinder body (27), an inner cylinder body (28), a piston assembly (29) and a N-S drive pin (30). The inner cylinder body (28) is arranged within the outer cylinder body (28) and are attached via the outer cylinder support (26) to the piston assembly holders (7) provided on the frame assembly (5). The piston assembly (29) traverses within the inner cylinder body (28) and is connected on either sides to the connecting rods (40/41, as the case may be). The piston assembly (29) is provided with the N-S drive pin (30). The N-S drive pin (30) is adapted to engage with the N-S lever assembly (15) provided on the panel holder assembly (12).

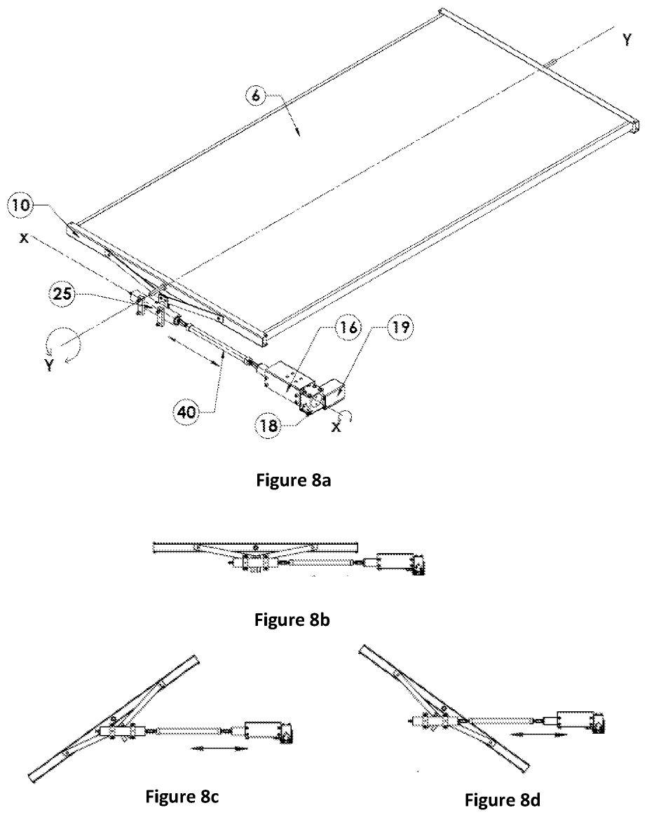

Now referring to FIG. 8a, there is illustrated a complete connection between the N-S motion imparting assembly (16) and the panel holder assembly (12). It can be seen that the N-S drive pin (30) is adapted to engage with the N-S lever assembly (15) (although this could not be numbered, as it is hidden) provided on the panel holder assembly (12). Now referring to FIGS. 8b to 8d, N-S tilting motion of the panel holder assembly (12) can be seen, wherein FIG. 8b illustrates the panel holder assembly (12) being in a central position, FIG. 8c illustrates the N-S motion imparting assembly causing the panel holder assembly (12) to exhibit a tilting movement towards north, and FIG. 8d illustrates the N-S motion imparting assembly causing the panel holder assembly (12) to exhibit a tilting movement towards south in accordance with an embodiment of the present invention.

The N-S motion imparting assembly (16) of the present invention is entirely different from the mechanism used in the earlier mechanisms. In the earlier solutions, each panel is tilted by a worm gear box from one side of the panel for N-S tilting. Such a mechanism has been found to be suffering from the following disadvantages:
(1) Warpage of panels was experienced when the tilting drive on one side only;
(2) There was back lash in the tilting and hence, the panels were oscillating to and fro from the point of tilting; and
(3) More torques was required to tilt, since the drive was given at the shaft of the panel itself.

On the other hand, in the mechanism of present invention, each panel is tilted by a mechanical linear gear box arrangement which is driven from both sides of the panel firmly supported by piston movement in a cylinder. Hence, when following the specific construction
(1) No warpage of the panels was observed, since the drive is from both sides of the panels.
(2) No back lash in the tilting was observed and hence the panel tilting is very firm and sturdy; and
(3) Optimum torque is required, since the drive is given on both sides of the panels by linear screw drive and acting on a panel tilting lever.

While the specific construction which imparts N-S tilting movement to the panel holder assemblies (12) was described with reference to FIGS. 4 to 8, hereinafter the specific construction which imparts E-W tilting movement to the frame assembly (5) will be described. In particular, the specific construction which enables the frame assembly (5) to exhibit tilting movement with respect to the pillar assemblies (3,4) which is being referred to as the E-W tilting movement will be described.

Referring back to FIG. 1, it can be seen that the pillar assemblies are of two types, namely a first pillar assembly (3) and a second pillar assembly (4). The second pillar assembly (4) does not have the capacity to impart motion to the frame assembly (5). The first pillar assembly (3) on the other hand, is provided with the means/mechanism that imparts the E-W tilting movement.

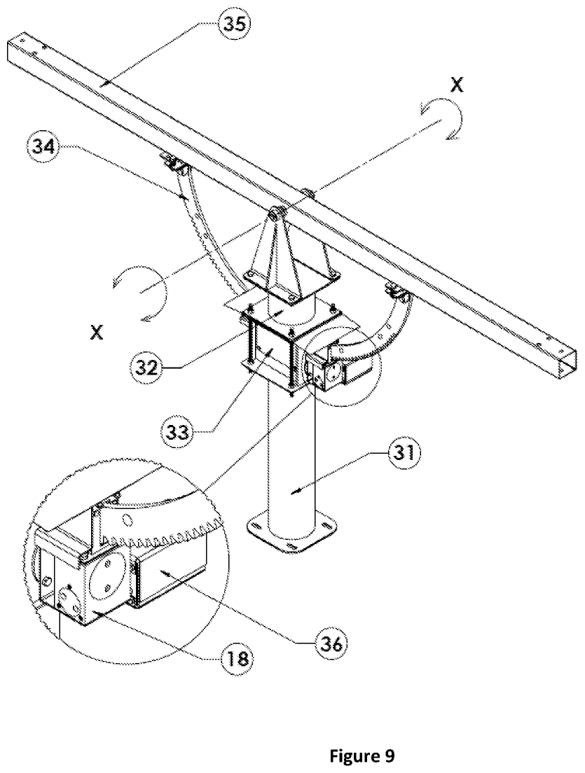

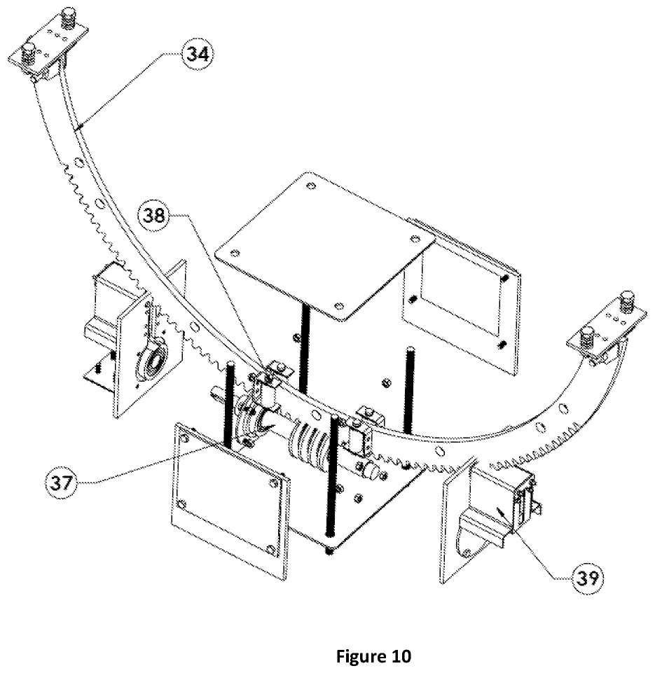

Now referring to FIG. 9 and FIG. 10, there is illustrated a detailed view of the pillar assembly (3) and the way the pillar assembly is connected to the frame assembly (5). In an embodiment of the invention, the pillar assembly (3) is operably connected to a cross frame (35). In particular, the pillar assembly (3) is pivotally connected to the cross frame (35).

The pillar assembly (3) comprises a bottom portion (31) and a top portion (32). Proximate to the top portion (32), the pillar assembly (3) is provided with an E-W motor (36) which is operably connected to a ring gear (34) via suitable gear box assembly (18, 33). The ring gear (34) is attached to a bottom side of the cross frame (35) (that forms part of the frame assembly (5)). In particular, the E-W motor (36) is connected to a first gear box (18). The first gear box (18) is connected to a second gear box (33), which is further connected to the ring gear (34). In particular, the E-W motor (36) is provided with a worm portion, which is operably connected to a worm wheel which form part of first gear box (18). The worm wheel is connected to a shaft (37) having centrally located worm portion (or threaded portion). The shaft (37) having centrally located worm portion (or threaded portion) is located within a dust stopper mechanism (39).

The ring gear (34) is in the form of a semi-circular plate having teeth cut on the external periphery. The teeth are provided to cover at least the angular titling in the E-W direction. The teeth as provided on the external periphery of the semi-circular plate engage constantly with the centrally located worm portion (or threaded portion) of the shaft (37). Additionally, a set of roller assemblies (38) are provided on either side of the ring gear (34) to ensure smooth angular movement of the ring gear (34). Thus, when the E-W motor (36) rotates in a first direction, it causes the worm wheel provided in the first gear box (18) to exhibit a rotational motion. As the worn wheel is connected to the shaft (37), the shaft also exhibits rotational motion.

Since the teeth as provided in the ring gear (34) are constantly engaged with the centrally located worm portion (or threaded portion) of the shaft (37), ring gear increments. Because the ring gear is in the form of a semi-circular plate, the semi-circular plate starts rotating at about its axis. Since the ring gear (34) is attached to the bottom side of the cross frame (35), the cross frame (35) starts rotating about the axis which is defined by the mounting bracket assemblies (42). In an embodiment of the invention, the pillar assembly (3) is provided with a mounting bracket assembly (42) which is pivotally connected to cross frame (35). Thus, it can be seen that only one pillar assembly (3) provided with a system as described above is sufficient to cause E-W tilting movement of the frame assembly (5). Thus, in the second pillar assembly (4) which does not have the capacity to impart motion to the frame assembly (5), a top portion of the pillar is provided with a mounting bracket assembly (42) to which a remaining cross frame (35) is pivotally connected.

Compared to the earlier solutions, the mechanism for imparting E-W motion in the present invention is entirely different. In earlier solution, the mechanism for imparting E-W motion imparts motion to a cluster of rows, while in the present invention; the mechanism for imparting E-W motion imparts motion to one independent row. The cluster row mechanism as disclosed in earlier solutionshas the following disadvantages:
(1) Multi rows are driven by a single motor. Thus, if the motor fails, the entire capacity will be idle;
(2) The alignment has to be perfect—otherwise, this will not function;
(3) One cannot install the cluster of rows on an undulated surface;
(4) Since, cluster of rows to be installed in one area, the land area will be wasted (small areas cannot be used to install one cluster of rows);
(5) We cannot install the cluster of rows on a sloped surface;
(6) One control for the one cluster. No independent row can be controlled separately;
(7) The interconnecting part between the rows of the cluster of rows architecture restricts the use of the ground space between the rows, since the rows are interconnected by a solid mechanical member and reciprocating. The use of ground space between the rows are necessary and very important for vehicular mobility in order to clean the panels, panels movement etc.; and
(8) Structure has more weight.

On the other hand, as per the teachings of the present invention, the present invention adopts independent row architecture, which has the following advantages:
(1) Every row is independent;
(2) No inter-dependence with other rows;
(3) We can install independent rows on an undulated surface;
(4) Land area can be effectively used and the land wastage can be minimized;
(5) No restrictions to install successive rows can be installed on a sloped surface;
(6) Every is row independent and hence every can be controlled separately;
(7) Because every row is independent, there exists free space between 2 successive rows and hence, one can have use this for vehicular mobility in order to clean the panels, panels movement etc.; and
(8) Structure weight is optimum.

Further, the present mechanism overcomes the problems in existing solutions that involve one gear box is used to drive a cluster of rows in the E-W tilting. Thus, the prior art mechanism has the following disadvantages:
(1) Multi rows are driven by a single motor-if the motor fails, the entire capacity will be idle.
(2) Size and power of the motor and the gear box was bigger and costly.

On the other hand, as per the teachings of the present invention, one gear box is used to drive one row only in the E-W tilting. Thus, every row is independently driven. Thus, even if the motor fails, only one row will be affected. Also, since, every row is driven by a single motor, the power and gear box are very small, compact and with least cost.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. Moreover, all elements shown in the diagrams need not be implemented. The scope of embodiments is by no means limited by these specific examples. Numerous variations, whether explicitly given in the specification or not, such as differences in structure, dimension, and use of material, are possible. The scope of embodiments is at least as broad as given by the following claims.

While specific language has been used to describe the disclosure, any limitations arising on account of the same are not intended. As would be apparent to a person in the art, various working modifications may be made to the method in order to implement the inventive concept as taught herein.

1. A horizontal dual-axis solar tracking system, comprising:
a frame assembly, wherein the frame assembly comprises a plurality of cross frames members;
a plurality of panel holder assemblies linked to the frame assembly, each panel holder assembly comprising a photovoltaic panel;
a first N-S motion imparting assembly and a second N-S motion imparting assembly co-operating with the plurality of panel holder assemblies and adapted to cause the plurality of panel holder assemblies to exhibit N-S tilting motion with respect to the frame assembly;
a plurality of pillar assemblies pivotally connected to the plurality of cross frames; and
a ring gear attached to a bottom surface of a cross frames, the ring gear being operably connected to an E-W motion imparting assembly located on the pillar assembly with which the cross frame is pivotally connected.

2. The horizontal dual-axis solar tracking system according to claim 1, wherein each panel holder assembly comprises a set of C-shaped panels adapted to be located on two opposing sides of the photovoltaic panel, wherein each C-shaped panel comprises a panel holder shaft and a N-S lever assembly, and wherein the panel holder assemblies are pivotally mounted in the frame assembly via the panel holder shafts.

3. The horizontal dual-axis solar tracking system according to claim 1, wherein the N-S lever assemblies arranged on a first side of the plurality of panel holder assemblies are connected to the first N-S motion imparting assembly and the N-S lever assemblies arranged on a second side of the plurality of panel holder assemblies are connected to the second N-S motion imparting assembly.

4. The horizontal dual-axis solar tracking system according to claim 1, wherein the frame assembly is of single frame assembly structure and comprises a pair of straight frame members which are parallel to one another; a plurality of cross frame members connected between the pair of straight frame members; a set of piston assembly holders; and a set of panel holder shaft provisions positioned on the straight frame members.

5. The horizontal dual axis solar tracking system according to claim 1, wherein the N-S motion imparting assembly comprises a lateral movement generating mechanism, a plurality of piston connection mechanism and a plurality of connecting rods for connecting the lateral movement generating mechanism with the piston connection mechanism and for interconnecting the plurality of piston connection mechanisms with one another.

6. The horizontal dual axis solar tracking system according to claim 6, wherein the lateral movement generating mechanism comprises N-S motor which is connected to a linear motion shaft via a suitable gear-box, wherein the N-S motor is provided with a worm portion, the worm portion being operably connected to a worm wheel; the worm wheel being connected to a threaded shaft, which is located between two junctions, with the linear motion shaft being connected to the threaded shaft.

7. The horizontal dual axis solar tracking system according to claim 6, wherein the piston connection mechanism comprises an outer cylinder support, an outer cylinder body, an inner cylinder body, a piston assembly and a N-S drive pin, wherein the inner cylinder body is arranged within the outer cylinder body and are attached via the outer cylinder support to piston assembly holders provided on the frame assembly.

8. The horizontal dual axis solar tracking system according to claim 9, wherein the piston assembly traverses within the inner cylinder body and is connected on either sides to the connecting rods; the piston assembly is provided with the N-S drive pin, the N-S drive pin being adapted to engage with the N-S lever assembly provided on the panel holder assembly.

9. The horizontal dual axis solar tracking system according to claim 1, wherein pillar assemblies are of two types, namely a first pillar assembly and a second pillar assembly, the first pillar assembly is provided with a mechanism that imparts the E-W tilting movement and the second pillar assembly does not impart motion to the frame assembly.

10. The horizontal dual axis solar tracking system according to claim 1, wherein the pillar assembly comprises a bottom portion and a top portion, an E-W motor disposed proximate to the top portion, and a ring gear operably connected to the E-W motor via gear box assembly.

11. The horizontal dual axis solar tracking system according to claim 1, wherein:
the E-W motor is provided with a worm portion, which is operably connected to a worm wheel, the worm wheel is connected to a shaft having a centrally located worm portion or a threaded portion; and
the ring gear is constantly with the centrally located worm portion or the threaded portion of the shaft.

12. The horizontal dual axis solar tracking system according to claim 1, wherein:
the ring gear is in the form of a semi-circular plate having teeth cut on the external periphery;
the teeth are provided to cover at least the range of angular titling in the E-W direction; and
a set of roller assemblies are provided on either side of the ring gear to ensure smooth angular movement of the ring gear.
